(19) United States
(12) Patent Application Publication
(10) Pub. No.: US 2019/0160391 A1
(43) Pub. Date: May 30, 2019

(54) DEMILITARIZATION AND DISPOSAL OF HC SMOKE ORDINANCE

(71) Applicant: John Potee Whitney, Dallas, TX (US)

(72) Inventor: John Potee Whitney, Dallas, TX (US)

(21) Appl. No.: 15/798,299

(22) Filed: Oct. 30, 2017

(51) Int. Cl. B01D 9/00

(52) U.S. Cl. CPC B01D 9/0031; F41H 9/08; B01D 9/0059; B01D 9/0013

(57) ABSTRACT

Demilitarization and disposal of HC smoke ordnance with recovery of constituents thereof as commodities entails mechanically removing from the ordnance a filler comprising hexachloroethane, zinc oxide and grained aluminum; heating the filler to a temperature above the sublimation temperature of hexachloroethane but safely below the temperature at which hexachloroethane chemically decomposes, and draining and collecting the dense hexachloroethane vapor; and conventionally separating the aluminum from the zinc oxide. Filler is supplied to and removed from a heating compartment from above; hexachloroethane drains via a lower portion of the heating compartment.

This application claims the benefit of earlier-filed U.S. Provisional Patent Application No. 62/414,772, filed 30 Oct. 2016, “DEMILITARIZATION AND DISPOSAL OF HC SMOKE ORDINANCE,” inventor John Potee Whitney.

### BACKGROUND OF THE INVENTION

### 1. Field of the Invention

The present invention relates to safely disposing of a hazardous chemical mixture, more particularly to the demilitarization and disposal of ordnance, especially to the safe and efficient disposal of a hazardous mixture which is unsuitable for incineration.

### 2. General Background and State of the Art

The world's militaries possess large inventories of obscurant smoke ordnance designed in the early to mid Twentieth Century for disrupting enemy military operations and manufactured before 1983. These inventories are dangerous. The manufacture of the type of ordinance in question here has been banned by treaty. However, existing inventories have not been effectively demilitarized, although various attempts have been made at considerable cost.

The constituents of the ordinance here under consideration are zinc oxide, hexachloroethane and grained aluminum. The CH smoke comprises an aerosol of zinc chloride having particle size ranging from single molecule to 0.4 micron mixed with an aerosol of alumina have particles size ranging from 0.4 to 2.5 microns. These aerosols account for 89% of the mass of the smoke. The other 11% comprises various chlorinated organic vapors. The smoke behaves as a high-density fume which scatters light and functions as an optical obscurant. The zinc chloride aerosol comprising a particulate of size less than 2.5 microns and averaging 0.4 microns, has a very high affinity for atmospheric water vapor and forms a high-density smoke which tends to stay low to the ground. The zinc chloride is a strong dessicant and combines with atmospheric water to form the smoke. Additionally, as a dessicant, this particulate destroys lung tissue on contact.

The ordnance produces zinc chloride as a product of the reduction of the zinc oxide (ZnO) followed by the oxidation of zinc by chlorine. The energy for the reaction is supplied by the exothermic oxidation, at high temperature, of fine-grained aluminum to alumina, the oxygen being supplied by the zinc oxide. The reactant mixture, known as the filler, is approximately 46.5% zinc oxide, 46.5% hexachloroethane and between 6% and 9% grained aluminum. The overall reaction of the filler in the canister is 2 Al+C₂Cl₆+3 ZnO→3 ZnCl₂+Al₂O₃+2 C+heat.

The ordnance comprises a metal container, perhaps better thought of as a canister. One type, manually activated, has a removable top closure with a fuse. Another, which lacks a fuse, is configured for insertion into a 105 mm or 155 mm projectile and is ignited by propellant flash when fired from an artillery piece.

There are three types of manually activated HC smoke canisters: the K865, M1, HC smoke pot weighing 12.5 lbs with 10 lbs. of filler; the K866, ABC M5, HC smoke pot weighing 33 lbs with 31 lbs of filler; and the K867, M4A2, floating smoke pot weighing 38 lbs with 27.5 lbs of filler (by filler, the Army means the mixture that, when ignited, produces the smoke). Each canister has a removable metal top supplying a method of igniting a fuse which ignites the filler. The K865 and K866 have the fuse and igniter mix mechanically bound in a small structure on the inner surface of the top of the canister containing the filler material. The K867 has a fuse train-igniter with a pistol grip in a cavity on the top of the enclosure to the filler.

The canister configured for delivery by projectile has a center flame tube coated with fraction of an ounce of starter mix that serves as a fast fuse-igniter. In all configurations, the aluminum in the filler is ignited by dense phase combustion of the starter mix, which requires lower activation energy but is capable of producing the required temperature to ignite the filler. None of the steps requires externally supplied oxygen.

The traditional method of ordnance demilitarization is incineration. With the HC smoke ordnance mixture, incineration produces zinc chloride (ZnCl₂), which is a vapor above 1350° F. at a pressure of one atmosphere, and is a liquid down to a temperature of 550° F. As a severe inhalation hazard, this vapor must not be discharged into the environment. It is subject to environmental regulation as a type of hazardous waste. Management of the life cycle of such a material must be conducted in compliance with EPA rules.

As a liquid from 1350° F. to 550° F., zinc chloride produces wet-dry interfaces at the vapor dew point of 1350° F. and the solidification/crystallization temperature of 550° F. Consequently, any duct carrying zinc chloride vapor is subject to fouling by an accumulation of adhered solids. Fouling of ducts has frustrated attempts to incinerate HC smoke ordnance.

Additionally, the decomposition products of incineration of HC smoke ordnance include hydrogen chloride (HCl) and phosgene (Cl₂CO). Phosgene is a deadly poison gas. Therefore, incineration of HC smoke ordnance is extremely hazardous.

Yet another difficulty of incinerating HC smoke ordinance is that scrubbing equipment is required in order to remove the incineration products from the exhaust gas stream emerging from the incinerator. The scrubbing equipment must be made with expensive alloys in order to withstand contact with zinc chloride, because it is a chlorinated salt.

Another factor counting against incineration is that the output of incineration has nearly the same mass as the input, because only the mass of the fuse and the igniter are lost in the process. This mass still must be disposed of as hazardous waste incinerator ash.

For the above reasons, as an approach to disposing of HC smoke ordnance, incineration has led to a series of costly failures with no practical solution in sight.

### INVENTION SUMMARY

It is an object of the present invention to safely, legally, economically dispose of HC smoke ordinance.

In accordance with this object and with others which will be described and which will become apparent, an exemplary method for demilitarizing HC smoke ordnance where the ordinance comprises a filler having the constituents hexachloroethane, zinc oxide and grained aluminum and recovering components thereof includes steps of liberating hexachloroethane from the filler; collecting the hexachloroethane; and, after the step of liberating, separately collecting a solid residue of the filler.

The step of liberating may include a step of heating the filler. Additionally, this step of heating may be carried out with temperature and pressure such as to cause the hexachloroethane to separate from the filler and such as not to cause chemical decomposition of any constituent of the filler.

Moreover, this step of heating may be carried out with temperature below 572° F. and high enough to result in a phase change of the hexachloroethane.

Still further, this step of heating may be carried out with temperature above 372° F. and below 572° F., and even more particularly, between 400° F. and 500° F.

This heating may be done at ambient environmental pressure.

This heating may be done at a pressure maintained below one atmosphere.

The step of collecting the hexachloroethane may include removing the hexachloroethane via a path maintained at a temperature below 572° F. and high enough to prevent obstruction of the path by accumulation of hexachloroethane.

This path may lead to a crystallizer.

The heating may be carried out in a heating compartment, the method including, after the step of liberating hexachloroethane, a step of conveying remaining filler solids from the heating compartment.

The method may include a step of gravitationally draining hexachloroethane from the filler.

The heating compartment may include a drain located to collect gravitationally draining liberated hexachloroethane.

The hexachloroethane may be drained along a path maintained at a temperature below 572° F. and high enough to prevent obstruction of the path by accumulation of hexachloroethane, the path including the drain.

The heating compartment may have an upper portion and a lower portion, the step of liberating being carried out in the lower portion; the method including, before the step of liberating, a step of supplying the filler to the heating compartment via the upper portion.

The step of separately collecting a solid residue may be carried out via the upper portion.

After the step of liberating, ther may be a step of separating grained aluminum from zinc oxide.

The step of separating grained aluminum from zinc oxide may be accomplished with an eddy current separator, air classifier, or screen.

The step of heating may be accomplished with a fluid indirect heating medium which becomes ineffective as a heat transfer medium at any temperature above a predetermined safe temperature, the safe temperature being below 572° F.

Before the step of heating, there may be a step of pre-heating the heating compartment to a sufficient temperature to prevent deposition of hexachloroethane in the heating compartment.

### BRIEF DESCRIPTION OF THE DRAWINGS

For a further understanding of the objects and advantages of the present invention, reference should be had to the accompanying document, seven pages in length, titled “Ammunition Demilitarization HC Smoke Post Award W52P1J-15-C-0088,” which illustrates and describes the types of HC smoke ordnance referenced herein.

For a further understanding of the objects and advantages of the present invention, reference should be had to the following detailed description, taken in conjunction with the accompanying drawing, in which like parts are given like reference numbers and wherein:

FIG. 1 is a perspective view of an M1 10-lb. HC smoke pot K865 (itself not part of the invention) to be processed in accordance with the present invention;

FIG. 2 is a perspective view of an ABC-M5 30-lb. HC smoke pot K866 (itself not part of the invention) to be processed in accordance with the present invention;

FIG. 3 is a side cut-out view of a floating, HC, M4A2 K867 (itself not part of the invention) to be processed in accordance with the present invention;

FIG. 4 is a side sectional view of a smoke canister M1 for 105 mm and 155 mm, C396 and D445 (itself not part of the invention), to be processed in accordance with the present invention; and

FIG. 5 illustrates schematically an arrangement of a processing chamber and two alternative approaches to the crystallization step in accordance with the present invention.

### DETAILED DESCRIPTION OF THE PREFERRED EMBODIMENTS

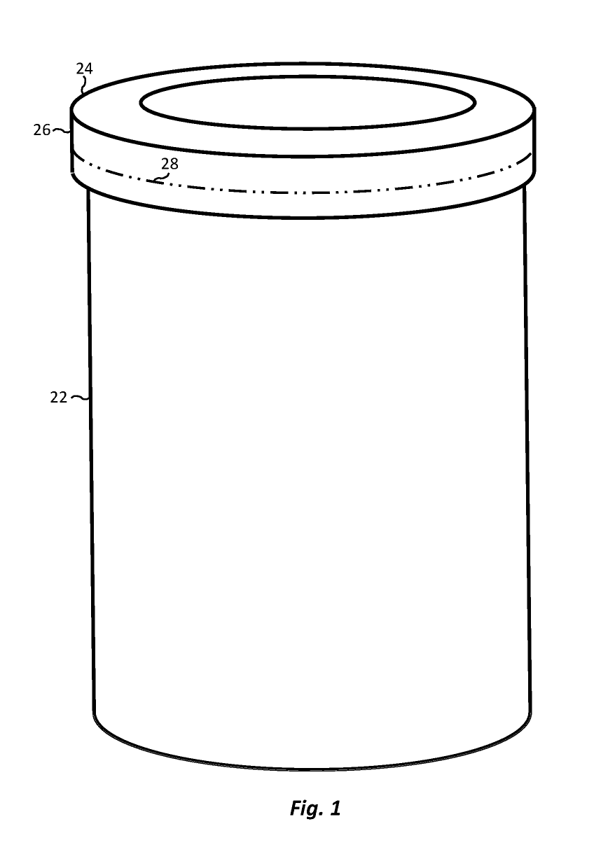

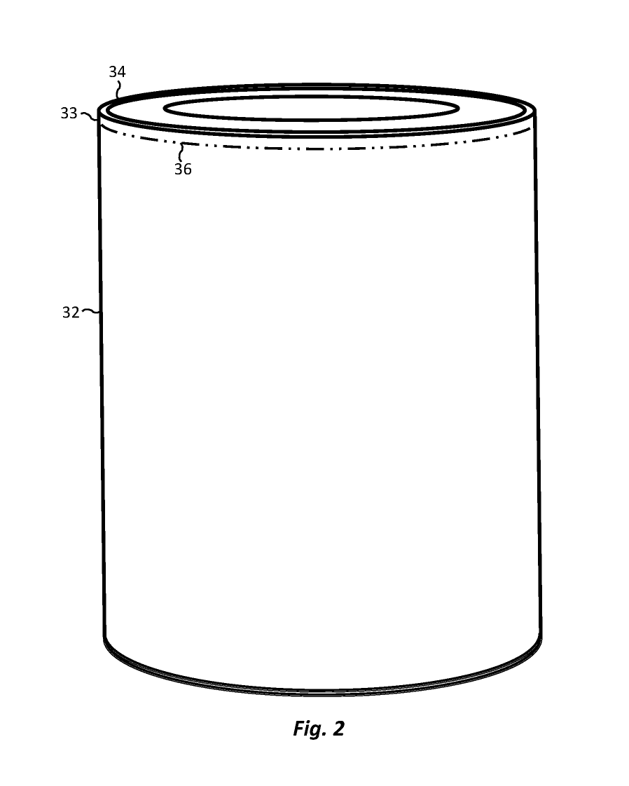

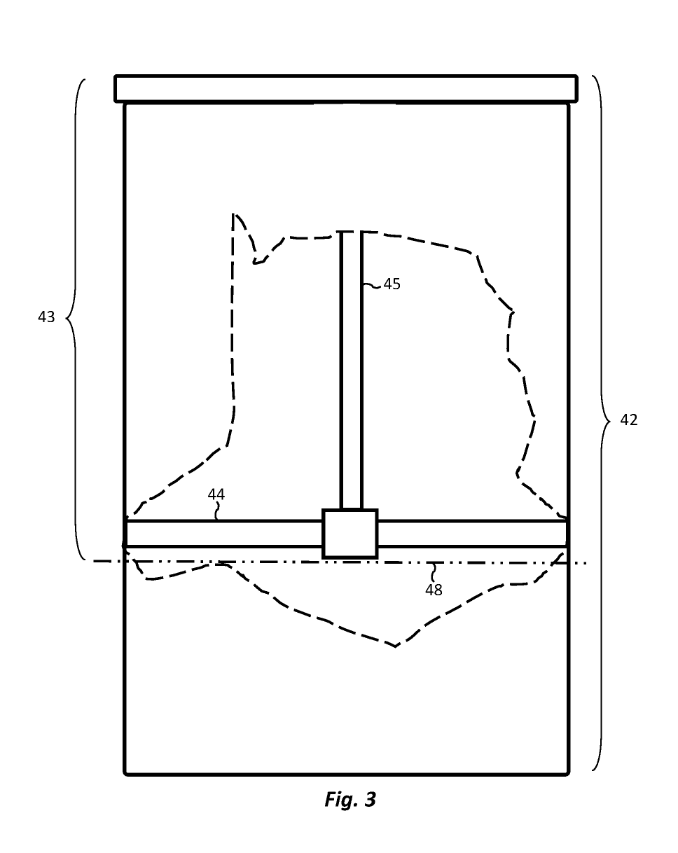

The invention will now be described with reference to FIGS. 1-4, which illustrate preferred methods of processing HC smoke ordinance in accordance with the present invention. FIG. 1 shows a perspective view of an M1 10-lb. HC smoke pot K865, roughly cylindrical in shape, having a body portion 22, an upper portion 24 (containing a fuse, not shown), and a top seam 26. A cut line 28 is shown. FIG. 2 shows a perspective view of an ABC-M5 30-lb. HC smoke pot K866, also roughly cylindrical in shape, having a body portion 32, an upper portion 33 (containing a fuse, not shown), and a top seam 34. A cut line 36 is shown. FIG. 3 shows a perspective view of a floating, HC, M4A2 K867 smoke pot, also roughly cylindrical in shape, having a body portion 42, an upper portion 43 (containing a fuse), a diaphragm 44 below which a smoke-generating filler material (not shown) is contained, and a fuse portion 45 affixed to the upper portion 43. A cut line 48 is shown.

For smoke pots as shown in FIGS. 1-3, the pot is chucked and rotated while a rotary parting tool (not shown) (cuts in the manner of a pipe cutter or tube cutter) is brought into contact with the cylindrical body portion (22, 32, 42) at the cut line (28, 26, 48). The parting tool severs the upper portion (24, 33, 43) from the body portion (22, 32, 42) without generating sparks or heat, thereby safely allowing the upper portion and fuse to be separated from the body portion of the pot, which contains the smoke-generating HC filler.

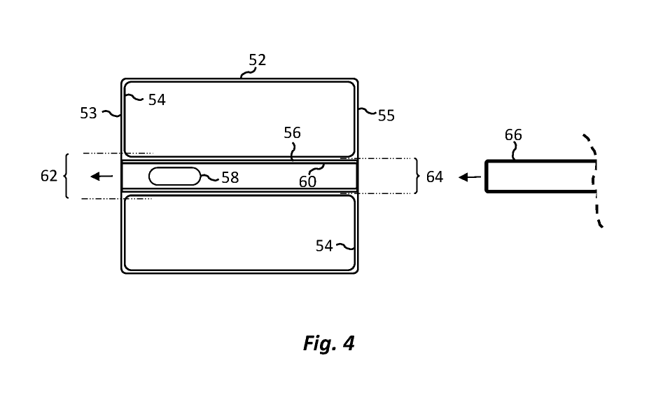

FIG. 4 shows a side sectional view of a smoke canister M1 for 105 mm and 155 mm, C396 and D445, having a cylindrical body portion 52 with a first end 53 and a second end 55. A flame tube 56 typically having an orifice 58 is disposed in the body portion 52. A starter 60 coats the inner surface of the flame tube 56.

For smoke canisters as shown in FIG. 4, a rotating hollow punch or a Hogan bit (not shown—these are tools of the type that would be used to cut holes in a sheet metal electrical junction box) is used to cut a first hole having a first diameter 62 in the first end 53. Likewise, a second hole having a second diameter 64 is cut in the second end 55. The first hole 62 has a diameter slightly larger than the outside diameter of the flame tube 56. The second hole 64 has a diameter equal to the outside diameter of the flame tube 56. The punch or bit is used to cut the holes 62 and 64 in a manner which does not generate sparks or heat. A center punch, having a diameter which is large enough to fully engage the flame tube 56 rather than traveling within the flame tube 56, yet small enough to pass through the second hole 64, is inserted in the second hole 64 and is advanced toward the first hole 62. As a result, the flame tube 56, the inner surface of which is coated with the starter 60, is safely forced out of the first hole 62 and may then be carried away.

The inventor desired to dispose of HC smoke ordnance in a way which avoids these problems. Additionally, the inventor sought to recover the constituents of the HC smoke ordinance mixture, all of which are valuable chemical commodities with important industrial applications. Even the hexachloroethane is valuable. While hexachloroethane must be shipped, handled and stored as a hazardous material, it is not classified as hazardous waste. The steel parts of the canister are also recyclable as scrap. The fuse and the igniter are non-chlorinated and therefore are easily and safely disposed of by conventional means without producing hazardous waste.

With the manually activated K865, K866, and K867, the inventor first removed the fuse-igniter train. These items are mechanically bound to the metal container. The top of the container is removed by cutting the sheet metal just below the top seam, as detailed above. The top and the igniter are separated from the canister, as detailed above, and are removed to a safe distance. The filler is removed from the canister by dumping, vibration, or mechanical drilling or cutting, or washing. The empty metal container is cleaned and recycled as scrap. The top and the fuse-igniter are separately processed at a safe distance from the filler material. The metal canister top and the fuse are cleaned to remove traces of hexachloroethane. Once the hexachloroethane is separated from the fuse-igniter, there is no danger of forming the objectionable ZnCl₂. The filler powder that is removed from the canister is quickly removed from the location where cleaning occurs, to prevent accidental ignition should a fuse-igniter train become activated. The top with the igniter attached is unsafe, being pyrophoric. Therefore, it is deposited in appropriate containment for further processing by incineration or acid or base hydrolysis.

The filler is then placed into a process chamber to raise the temperature to greater than the sublimation temperature of the hexachloroethane at the pressure of the chamber. Hexachloroethane vapor, being approximately eight times as dense as air, flows to the bottom of the chamber where it is drawn by lower pressure into a condensation or crystallization chamber.

One manner of isolating the hexachloroethane is accomplished by mixing the hexachloroethane gas, which sublimes at 512° F., with tetrachloroethylene (also known as perchloroethylene), a liquid which is introduced at a much lower temperature than that of the hexachloroethane gas, to produce a liquid solution. In producing this solution, the mass of the perchlorethylene must be sufficient, relative to that of the hexachloroethane, that the temperature of the resulting solution remains below 250° F. With the aid of a heat exchanger, the solution is heated and the perchloroethylene is pulled off with a vacuum sufficient to maintain a temperature at which the crystals of hexachloroethane can be filtered from the liquid perchloroethylene in the chrystallizer. The hexachloroethane crystals are then removed, washed, packaged, and sold.

Alternatively, cold liquid water is sprayed into a steam of hexachloroethane gas in a contacting chamber, cooling the hexachloroethane below 372° F., causing the hexachloroethane to crystallize. The resulting mixture is filtered, whereby the hexachloroethane crystals are collected for subsequent sale.

The solid material remaining after the hexachloroethane has vaporized is removed from the process chamber. The aluminum grains are separated from the zinc oxide powder by eddy current separators, screening, air classification, or any of several well known methods.

In the ordnance configured for projectile delivery, there is no striker-match. Rather, the canister is equipped with a central flame tube which allows propellant flash to ignite the starter mix when the round is fired. The starter mix is a thin coating on the filler. Thus, for purposes of disposal, there a different method must be used to remove the starter mix from the filler. Thus, as a preliminary step, the inventor cut a hole in both ends of the canister concentric with the center flame tube, one hole having larger diameter than the other, as detailed above. Through the smaller hole, the inventor pressed a center punch into the canister, the punch having a diameter slightly larger than the flame tube and large enough to disengage the starter and the flame tube from the filler and push them both out of the larger hole at the other end of the canister, thereby separating the starter from the filler. The inventor washed the flame tube and starter that were removed from the filler, to ensure that they were not contaminated with filler. After the flame tube and the starter were removed from the canister, the filler was pushed, scraped, or shaken, to the extent necessary, to remove it from the canister. The empty canister was washed so that it was free of filler. Thus, the canister, flame tube (if any) and top are classified as “Designated Safe Material,” such that they are economically transported without special permit.

Accordingly, the present invention provides a method for demilitarizing HC smoke ordnance where the ordinance comprises a filler having the constituents hexachloroethane, zinc oxide and grained aluminum and recovering components thereof, the method including steps of liberating hexachloroethane from the filler; collecting the hexachloroethane; and after the step of liberating, separately collecting a solid residue of the filler. The step of liberating may include a step of heating the filler, a step of reducing the pressure below ambient pressure, or both. Heating should be to a temperature which, under practical conditions, such as ambient pressure approximately one atmosphere or pressure reduced with the use of suction or vacuum and an air lock, is high enough to cause the hexachloroethane to separate from the filler, but not high enough to cause chemical decomposition of any constituent of the filler. To avoid chemical decomposition of hexachloroethane, the temperature should remain below 572° F. Aluminum and zinc oxide are stable until they reach temperatures considerably higher than this.

The step of heating may be carried out with temperature below 572° F. and high enough to result in a phase change of the hexachloroethane and, more preferably, between 400° F. and 500° F. Ambient environmental pressure is convenient; however, the removal of hexachloroethane may be accomplished more rapidly at a pressure below one atmosphere.

The step of collecting the hexachloroethane may include removing the hexachloroethane via a path maintained at a temperature below 572° F. and high enough to prevent obstruction of the path by accumulation of hexachloroethane. The path may lead to a crystallizer.

After the step of liberating hexachloroethane, the method may include a step of conveying remaining filler solids from the heating compartment.

Collecting hexachloroethane may be accomplished by gravitationally draining hexachloroethane from the filler, preferably to a drain located in the heating compartment so as to collect gravitationally draining liberated hexachloroethane.

Hexachloroethane may be drained along a path maintained at a temperature below 572° F. and high enough to prevent obstruction of the path by accumulation of hexachloroethane, the path including the drain.

The heating compartment may have an upper portion for supply of filler and removal of remaining solids and a lower portion for carrying out the step of liberating the hexachloroethane. Being much denser than air, the hexachloroethane pools in the lower portion rather than flowing upward and escaping via the upper portion. After removal from the heating chamber, the solids can be subjected to further processing (although they may be sold as a mixture), such as a step of separating grained aluminum from zinc oxide by means of, e.g., an eddy current separator, air classifier, or screen, flotation, or other known means.

To provide inherent safety in the avoidance of decomposition of hexachloroethane, the step of heating may be accomplished with a fluid indirect heating medium which becomes ineffective as a heat transfer medium at any temperature above a predetermined safe temperature, the safe temperature being below 572° F. For example, an oil having a boiling point at the safe temperature may be circulated in a heat transfer loop which is not capable of sustaining flow with the oil at or near the boiling point. Overheating of the oil would impair its circulation and reduce the likelihood of overheating the heating compartment and chemically decomposing the hexachloroethane.

The heating compartment may be pre-heated to a controlled temperature, above 372° F. and a safe margin below 572° F., preferably less than 550° F., to prevent deposition of hexachloroethane when filler is first supplied.

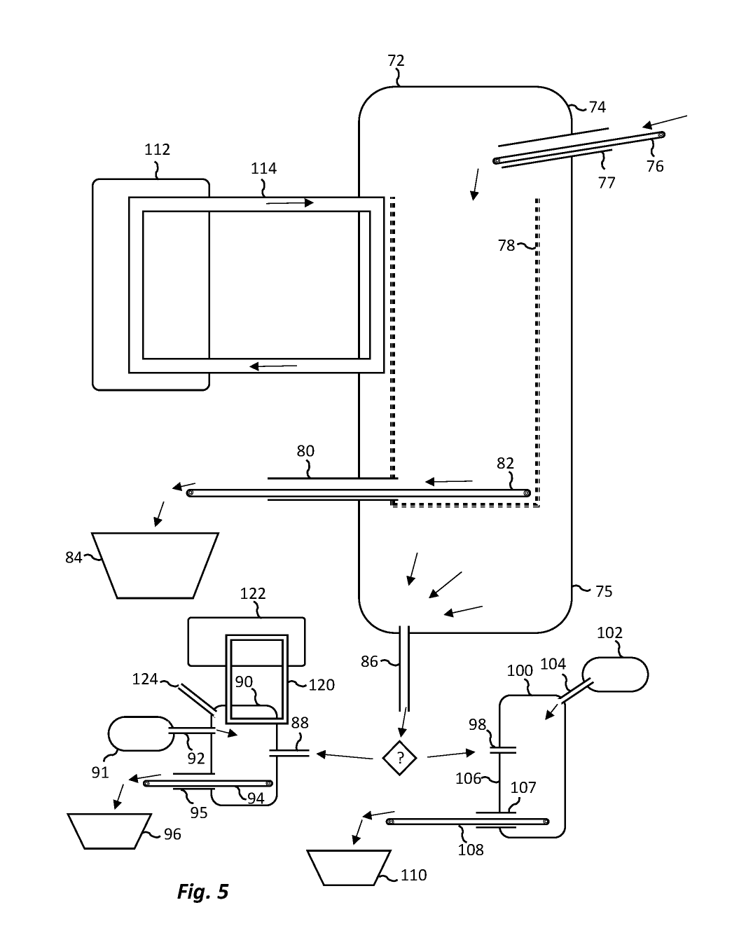

FIG. 5 illustrates schematically an arrangement of a processing chamber for use as described above, with two alternative approaches to the crystallization step as described above, in accordance with the present invention. Processing chamber 72 has an upper portion 74, lower portion 75, solids basket 78, filler intake 77 with conveyor 76 located in the upper portion 74, solids output 80 with conveyor 82 leading to bucket 84, indirect heat loop 114 with heater 112, and a vapor drain 86 located in the lower portion 75.

The vapor drain may lead to various crystallization chamber arrangements. A first such arrangement, for making the perchlorethylene-hexachloroethane solution and crystallizing hexachloroethane from that solution, includes a mixing or condensation chamber 90 with a vapor intake 88, a tetrachloroethane supply 91 with supply tube 92, and crystal output 95 with conveyor 94 leading to bucket 96. A heating or cooling apparatus 122 coupled with a heat exchange loop 120 is provided for temperature control. A vacuum line 124 is provided to control pressure.

A second such arrangement, for cooling the hexachloroethane vapor to make crystals as described above, includes a vapor intake 98 leading to a contacting chamber 106 with an upper portion having a water spray line 104 connected to a water supply 102. A crystal output 107 with conveyor 108 leads to a bucket 110. The conveyors shown at 108, 94 and 82 are intended merely to indicate the role performed. An auger or various other structures might be employed to move crystals or solids as needed. Similarly, the location, dimensions and orientation of the various intakes, outputs, tubes, lines and drains shown are intended merely to illustrate the overall arrangement and cooperation of the illustrated embodiments. Thus, for example, the drain 86 might well require a closure of some sort, and a mover of some kind might be provided to better manage flow of vapor if desired.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

We claim:

1. A method for demilitarizing HC smoke ordnance where the ordinance comprises a filler having the constituents hexachloroethane, zinc oxide and grained aluminum and recovering components thereof, the method including steps of:
liberating hexachloroethane from the filler;
collecting said hexachloroethane; and
after said step of liberating, separately collecting a solid residue of the filler.

2. The method of claim 1, wherein said step of liberating includes a step of heating the filler.

3. The method of claim 2, wherein said step of heating is carried out with temperature and pressure such as to cause the hexachloroethane to separate from the filler and such as not to cause chemical decomposition of any constituent of the filler.

4. The method of claim 3, wherein said step of heating is carried out with temperature below 572° F. and high enough to result in a phase change of the hexachloroethane.

5. The method of claim 4, wherein said step of heating is carried out with temperature between 372° F. and 572° F.

6. The method of claim 4, wherein said pressure is ambient environmental pressure.

7. The method of claim 4, wherein said pressure is maintained below one atmosphere.

8. The method of claim 3, wherein said step of collecting said hexachloroethane includes removing said hexachloroethane via a path maintained at a temperature below 572° F. and high enough to prevent obstruction of said path by accumulation of hexachloroethane.

9. The method of claim 8, wherein said path leads to a crystallizer.

10. The method of claim 2, carried out in a heating compartment, the method including, after said step of liberating hexachloroethane, a step of conveying remaining filler solids from said heating compartment.

11. The method of claim 1, including a step of gravitationally draining hexachloroethane from the filler.

12. The method of claim 10, said heating compartment including a drain located to collect gravitationally draining liberated hexachloroethane.

13. The method of claim 12, wherein said step of collecting said hexachloroethane includes draining said hexachloroethane along a path maintained at a temperature below 572° F. and high enough to prevent obstruction of said path by accumulation of hexachloroethane, said path including said drain.

14. The method of claim 10, wherein:
said heating compartment has an upper portion and a lower portion;
said step of liberating is carried out in said lower portion; and
the method includes, before said step of liberating, a step of supplying the filler to said heating compartment via said upper portion.

15. The method of claim 14, wherein said step of separately collecting a solid residue is carried out via said upper portion.

16. The method of claim 15, including, after said step of liberating, a step of separating grained aluminum from zinc oxide.

17. The method of claim 16, wherein said step of separating grained aluminum from zinc oxide is accomplished with an eddy current separator, air classifier, or screen.

18. The method of claim 2, wherein said step of heating is accomplished with a fluid indirect heating medium which becomes ineffective as a heat transfer medium at any temperature above a predetermined safe temperature, said safe temperature being below 572° F.

19. The method of claim 2 including, before said step of heating, a step of pre-heating said heating compartment to a sufficient temperature to prevent deposition of hexachloroethane in said heating compartment.

20. The method of claim 4, wherein said step of heating is carried out with temperature between 400° F. and 500° F.
